(19) United States
(12) Patent Application Publication
(10) Pub. No.: US 2003/0157062 A1
(43) Pub. Date: Aug. 21, 2003

(54) Method for exterminating termites

(76) Inventors: Kenji Mikami, Ibaraki (JP); Satoshi Yamanaka, Ibaraki (JP)

Correspondence Address: SUGHRUE MION, PLLC, 2100 PENNSYLVANIA AVENUE, N.W., WASHINGTON, DC, 20037, US

(21) Appl. No.: 10/220,808

(22) PCT Filed: Mar. 8, 2001
(86) PCT No.: PCT/JP01/01818

(30) Foreign Application Priority Data
Mar. 10, 2000 (JP) 2000-66307

(51) Int. Cl. A01N 63/00; A01N 43/66; A01N 25/00

(52) U.S. Cl. 424/93.1; 514/245

(57) ABSTRACT

A method for exterminating termites comprising using an entomopathogenic nematode together with an inset-growth regulator or a slow-acting insecticide, wherein insecticidal effects are reinforced compared with the cases using singly the entomopathogenic nematode and the insect-growth regulator or the slow-acting insecticide, respectively, and a bait station for exterminating termites that contains an entomopathogenic nematode with an insect-growth regulator or a slow-acting insecticide. According to the invention, emission of harmful chemicals to environment can be suppressed. The invention is nonpoisonous for human being and livestock, and is useful for indoor or outdoor extermination of termites.

### TECHNICAL FIELD

The present invention relates to a method for exterminating termites comprising using an entomopathogenic nematode together with an insect-growth regulator or a slow-acting insecticide.

More specifically, the present invention relates to a method for exterminating termites comprising combining an entomopathogenic nematode belonging to the family Steinernematidae with an insect-growth regulator having insect chitin synthesis inhibiting activity, cuticle hardening activity or juvenile hormone-like activity, or a slow-acting insecticide which exhibits insecticidal activity slowly, thereby obtaining greater effects, compared with the cases using singly an insect-growth regulator, a slow-acting insecticide or an entomopathogenic nematode, to enable eradication of termites living in soils or celluloses and of colonies that termites inhabit.

### BACKGROUND ART

Termites feed on architectural structures, and woods or cellulose sources, and break into buildings from the surrounding soil.

As a method for preventing architectural structures from being damaged by termites, chemical insecticides, such as organophosphorus insecticides, carbamate insecticides and pyrethroid insecticides, as contact toxicants, may be distributed over the likely places in the house where termites have intruded into or in the soil where termites inhabit. However, of these, organophosphorus and carbamate insecticides need to be handled with care because of high levels of toxicity against human being, livestock and non-target insects, although these insecticides would exert prolonged-action performance that the effect endures for a long time. Furthermore, pyrethroid insecticides have high levels of toxicity against almost all insects including a target insect, and also have a problem that the persistence of effect is low.

All of these insecticides are used for targeting mainly on discovered termites. Therefore, the conventional methods for exterminating termites could perish termites that are in contact with the chemical insecticides used within a short period of time, but they have little effect against termites that are away from the insecticides. Moreover, in order to prevent damage by termites, a great amount of insecticides needs to be spread over the ground periodically as a soil treatment agent. In this case, the insecticides flow out into the soil, thereby being a cause of environmental pollution.

On the other hand, as methods using biological exterminating materials, it has been reported that Metarhizium anisopliae, a microbe pathogenic to termites, or nematodes being parasite on insect(hereafter referred to as entomopathogenic nematodes) can be used. Entomopathogenic nematodes for use in exterminating harmful insects, which are commercially interesting, are nematodes belonging to the order Rhabditida, the family Steinernematidae. These nematodes have a feature that they intrude into bodies of insects and damage the bodies by the action of symbiotic bacteria therein, thereby killing the insects (Parasitol., 1966, Vol.56, p.385; J. Syst. Bacteriol., 1979, Vol.29, p.352).

An infective third-stage juvenile of entomopathogenic nematodes belonging to the family Steinernematidae that have intruded into a termite body moves into a blood vessel (hemocoel), and excretes symbiotic bacteria that exist in the intestine of the nematode itself from the mouth and the anus. These symbiotic bacteria proliferate in the termite body to suppress the immune system of termites, thereby causing septicemia to death. Furthermore, since termites eat the carcasses of other termites, nematodes migrate into other living termites by way of the carcasses, thereby spreading over all the colonies. Thus, the function of entomopathogenic nematodes is exhibiting not only insecticidal activity inside the colonies in the same way as bait toxicants for termites, but also the secondary effect that results from proliferation inside the termite body, increase in density of the infective third-stage juvenile, and infection to the next host. Thus, slow insecticidal activity can be expected by the use of entomopathogenic nematodes.

However, since single use of entomopathogenic nematodes is weak in contagion, the resulted effect is low. Moreover, since nematodes would be dead if they could not infect termites, persistence of long-term effects cannot be expected.

Accordingly, it is an object of the present invention to provide a method for exterminating termites that damage architectural structures and that try to intrude therein, and for eradicating colonies of termites that nidificate in their habitat.

Furthermore, another object of the present invention is to provide a short-term or mid- or long-term method for exterminating termites that enables a great reduction in the amount of chemical insecticides conventionally used which have environmental and sanitary problems, and that simultaneously utilizes nematodes as biological exterminating materials.

### DISCLOSURE OF THE INVENTION

In light of the above objects, the present inventors have studied on combined use of insect-growth regulators, N-[[[3-chloro-4-(1,1,2-trifluoro-2-trifluoromethoxyethoxy)phenyl] amino] carbonyl]-2,6-difluorobenzamide (general name: novaluron), N-[[(4-chlorophenyl)amino]carbonyl]-2,6-difluorobenzamide (general name: diflubenzuron) and N-[[(3,5-dichloro-2,4-difluorophenyl)amino]carbonyl]-2,6-difluorobenzamide (general name: teflubenzuron), and an entomopathogenic nematode, Steinernema carpocapsae, and have found that, surprisingly, the combination exhibits outstandingly synergistic insecticidal activity compared with single use of these materials, and not only termites that damage architectural structures but also termites that try to intrude structures or inhabit the soil or celluloses can be perished. It has been presumed that the colonies, the habitat of termites, can also be eradicated.

As mentioned above, by using an insect-growth regulator with an entomopathogenic nematode in combination, the insect-growth regulator can exhibit stronger and more persistent insecticidal action in a smaller amount than the regular amount when used singly. This could be because the insect-growth regulator inhibits or suppresses formation of chitin, exoskeleton of insects, to delay restoring to its healthy condition so that an entomopathogenic nematode can intrude more readily into a body of such a termite than into that of a healthy termite.

Furthermore, secondary effects inside the colonies are exhibited by the combination of an insect-growth regulator and an entomopathogenic nematode. That is, insect-growth regulators have also oviposit suppressing effects due to a lack of chitin formation, thereby decreasing the survival index. Entomopathogenic nematodes exterminate termites and after proliferating in the carcasses of the dead termites, infect other living termites to gradually spread over all the colonies, thereby being expected to show synergistic and slow-acting insecticidal effect.

Thus, the mechanism of the present invention that combines insect-growth regulators such as novaluron, diflubenzuron and teflubenzuron with an entomopathogenic nematode is naturally expected to be applicable to combinations of other insect-growth regulators with an entomopathogenic nematode, and also combinations of a slow-acting chemical insecticide that is effective against termites with an entomopathogenic nematode.

Accordingly, the present invention provides the following method for exterminating termites and a bait station for use in the method.

1) A method for exterminating termites comprising using an entomopathogenic nematode together with an insect-growth regulator or a slow-acting insecticide, wherein insecticidal effects are reinforced compared with the cases using singly the entomopathogenic nematode, the insect-growth regulator or the slow-acting insecticide.

2) The method for exterminating termites according to above 1), wherein the entomopathogenic nematode belongs to the family Steinernematidae.

3) The method for exterminating termites according to above 2), wherein the nematode belonging to the family Steinernematidae belongs to the genus Steinernema, Heterorhabditis or Neosteinernema.

4) The method for exterminating termites according to above 3), wherein the entomopathogenic nematode belonging to the genus Steinernema is Steinernema carpocapsae, Steinernema glaseri, Steinernema kushidai, Steinernema feltiae or Steinernema riobravis, the entomopathogenic nematode belonging to the genus Heterorhabditis is Heterorhabditis bacteriophora or Heterorhabditis megidis, or the entomopathogenic nematode belonging to the genus Neosteinernema is Neosteinernema longicurvicauda.

5) The method for exterminating termites according to above 1), wherein the insect-growth regulator is selected from triflumuron, diflubenzuron, teflubenzuron, hexaflumuron, lufenuron, novaluron, flufenoxuron, chlorfluazuron, cyromazine, methoprene, hydroprene, pyriproxyfen, fenoxycarb and kinoprene.

6) The method for exterminating termites according to above 1), wherein a bait station containing an entomopathogenic nematode with an insect-growth regulator or a slow-acting insecticide is used.

7) The method for exterminating termites according to above 1), wherein a bait station containing an insect-growth regulator or a slow-acting insecticide is installed, and then entomopathogenic nematodes are spread around the bait station.

8) The method for exterminating termites according to above 1), wherein together with treating termites with an insect-growth regulator or a slow-acting insecticide, entomopathogenic nematodes are spread over or around the treated termites.

9) A bait station for use in a method for exterminating termites according to above 1) to 7), wherein the bait station contains an insect-growth regulator or a slow-acting insecticide.

10) A bait station for use in a method for exterminating termites according to above 1) to 6), wherein the bait station contains an entomopathogenic nematode together with an insect-growth regulator or a slow-acting insecticide.

### BRIEF DESCRIPTION OF THE DRAWING

FIG. 1 is a perspective view of the testing container for use in testing of the exterminating method of the present invention using an entomopathogenic nematode together with an insect-growth regulator.

### DETAILED DESCRIPTION OF THE INVENTION

The present invention is described in detail below.

(1) Entomopathogenic Nematodes

Entomopathogenic nematodes for use in the present invention are not particularly limited as long as they can parasite the bodies of termites, thereby killing termites.

Specific examples include entomopathogenic nematodes of the family Steinernema, more specifically, nematodes belonging to the genera Steinernema, Heterorhabditis and Neosteinernema. Nematodes belonging to the genus Steinernema include Steinernema carpocapsae, Steinernema glaseri, Steinernema kushidai, Steinernema feltiae and Steinernema riobravis. Nematodes belonging to the genus Heterorhabditis include Heterorhabditis bacteriophora and Heterorhabditis megidis. A nematode belonging to the genus Neosteinernema includes Neosteinernema longicurvicauda.

(2) Insect-Growth Regulators

Insect-growth regulators for use in the present invention are not particularly limited as long as they have termite's chitin synthesis inhibiting activity, cuticle hardening activity, or juvenile hormone-like activity. Examples include the following (general name, and compound name after colon):

triflumuron:

2-chloro-N-[[[4-(trifluoromethoxy)phenyl]amino]carbonyl] benzamide,

diflubenzuron:

N-[[(4-chlorophenyl)amino]carbonyl]-2,6-difluorobenzamide,

teflubenzuron:

N-[[(3,5-dichloro-2,4-difluorophenyl)amino]carbonyl]-2,6-difluorobenzamide,

hexaflumuron:

N-[[[3,5-dichloro-4-(1,1,2,2-tetrafluoroethoxy)phenyl]amino]carbonyl]-2,6-difluorobenzamide,

lufenuron:

N-[[[2,5-dichloro-4-(1,1,2,3,3,3-hexafluoropropoxy)phenyl]amino]carbonyl]-2,6-difluorobenzamide,

novaluron:

N-[[[3-chloro-4-[1,1,2-trifluoro-2-(trifluoromethoxyethoxy)phenyl]amino]carbonyl]-2,6-difluorobenzamide,

flufenoxuron:

N-[[[4-[2-chloro-4-(trifluoromethyl)phenoxy]-2-fluorophenyl]amino]carbonyl]-2,6-difluorobenzamide,

chlorfluazuron:

N-[[[3,5-dichloro-4-[[3-chloro-5-(trifluoromethyl)-2-pyridinyl]oxy]phenyl]amino]carbonyl]-2,6-difluorobenzamide,

cyromazine:

N-cyclopropyl-1,3,5-triazine-2,4,6-triamine,

methoprene:

(E,E)-(±)-1-methylethyl 11-methoxy-3,7,11-trimethyl-2,4-dodecadienoate,

hydroprene:

(E,E)-(±)-ethyl 3,7,11-trimethyl-2,4-dodecadienoate,

pyriproxyfen:

2-[1-methyl-2-(4-phenoxyphenoxy)ethoxy]pyridine,

fenoxycarb:

ethyl [2-(4-phenoxyphenoxy)ethyl]carbamate, and

kinoprene:

(E,E)-(±)-2-propynyl 3,7,11-trimethyl-2,4-dodecadienoate.

(3) Slow-Acting Insecticides

Slow-acting insecticides for use in the present invention are not particularly limited as long as they slowly exhibit insecticidal activity after the exposure to termites.

Specific examples include inorganic slow-acting insecticides such as arsenious acid, sodium arsenite, calcium arsenite, lead arsenate, fenbutatin oxide, azocyclitin, silicon dioxide, sodium silicofluoride, potassium silicofluoride, sulfur, sodium fluoride, thallium sulfate, boric acid, sodium borate, zinc chloride, sodium thiosulfate, sodium selenate, sodium cyanide, and potassium cyanide, as well as the following organic slow-acting insecticides (general name, and compound name after colon):

hydramethylnon:

tetrahydro-5,5-dimethyl-2(1H)-pyrimidinone[3-[4-(trifluoromethyl)phenyl]-1-[2-[4-(trifluoromethyl)phenyl]ethynyl]-2-propenylidene]hydrazone,

sulfluramid:

N-ethyl-1,1,2,2,3,3,4,4,5,5,6,6,7,7,8,8,8-heptadecafluoro-1-octanesulfonamide,

nitenpyram:

N-[(6-chloro-3-pyridinyl)methyl]-N-ethyl-N′-methyl-2-nitro-1,1-ethenediamine,

acetamiprid:

N-[(6-chloro-3-pyridynyl)methyl]-N-cyano-N′-methylacetamidine,

imidacloprid:

1-[(6-chloro-3-pyridinyl)methyl]-N-nitro-2-imidazolidinimine, and

fipronil:

5-amino-1-[2,6-dichloro-4-(trifluoromethyl)phenyl]-4-[(trifluoromethyl)sulfinyl]-1H-pyrazole-3-carbonitrile.

(4) Method for Exterminating Termites

Methods for exterminating termites for use in the present invention are not particularly limited as long as they use the entomopathogenic nematode together with an insect-growth regulator or a slow-acting insecticide (hereafter simply referred to as a chemical agent). Examples of the embodiments include the following:

(1) A method comprising installing a chemical agent as a bait agent (bait toxicant), and subsequently spreading entomopathogenic nematodes around the chemical agent or around the places where water is used in the houses.

(2) A method comprising installing a bait station (bait toxicant container) containing a chemical agent and an entomopathogenic nematode.

(3) A method comprising treating termites with a chemical agent in the form of emulsion, hydrating agent, oil agent, granular hydrating agent, liquid agent or pellet agent, and spreading entomopathogenic nematodes over or around the place where the termites are treated.

By the above methods, termites can be exterminated effectively and their colonies also can be eradicated effectively.

### BEST MODE FOR CARRYING OUT THE INVENTION

The present invention is illustrated in further detail by the following examples, but the present invention is not limited to the examples.

### EXAMPLE 1

### Indoor Testing of Combined Use of an Entomopathogenic Nematode (Steinernema Carpocapsae) and an insect-growth regulator (novaluron).

The following tests (test numbers 1 to 16) were carried out based on testing methods and qualitative standards (I) for termiticidal effects of termiticide for soil treating (Japan Wood Preserving Association standard number 13, 1992). In the tests using entomopathogenic nematodes, operation of diffusive volatilization was not carried out.

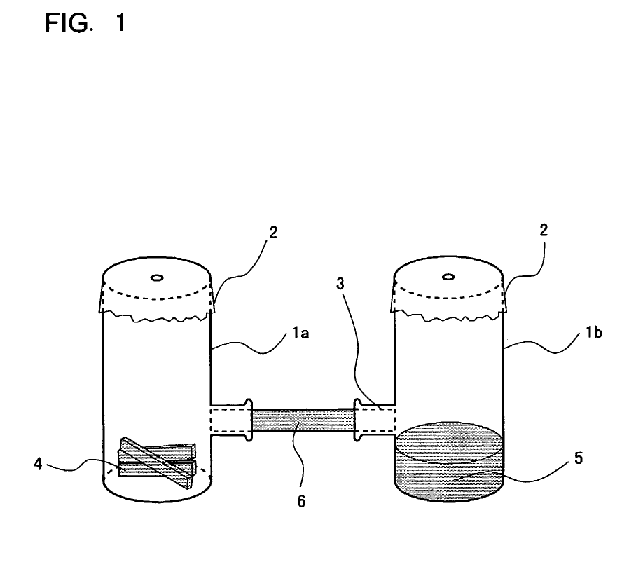

As shown in FIG. 1, two glass bottles (1a, 1b) (20 mm in diameter, 120 mm in height) with the upper portions open which can be covered with aluminum foil (2) if necessary, are used as testing containers. The bottom portions of these two glass bottles are connected with a glass tube (3) of 15 mm in diameter and 100 mm in length.

In one of the glass bottles of the testing container, about 60 g of a non-treated soil (5) having an adjusted moisture content of about 25% is placed, and in the other glass bottle, about 3 g of Japanese red pine wood blocks are placed, and in the central 50 mm portion of the glass tube, a treated soil for testing (6) is placed.

As treated soils for testing, as shown in Table 1, samples each containing 1000, 3000 or 10000 individuals of single Steinernema carpocapsae and samples each containing singly 10 ppm, 20 ppm or 50 ppm of novaluron, and samples containing a mixture of the prescribed amounts of Steinernema carpocapsae and novaluron were used.

In the glass bottle containing a non-treated soil, Coptotemes formosanus taken out from a nest was placed, and the upper portions of the glass bottles were covered with aluminum foil. Cumulative mortality rates after 0, 3, 5, 7, 10 and 14 days, respectively, were examined. The results are shown in Table 1.

TABLE 1

| | | Cumulative mortality rate (%) | | | | | |
|---|---|---|---|---|---|---|---|
| | | after a lapse of days | | | | | |
| | | Number of days elapsed | | | | | |
| Test No. | Composition of the treated soil | 0 | 3 | 5 | 7 | 10 | 14 |
| 1 | Non-treated | 0 | 0 | 0 | 0 | 0 | 0 |
| 2 | 1,000 indivs. of Steinernema carpocapsae | 0 | 10 | 15 | 20 | 40 | 40 |
| 3 | 3,000 indivs. of Steinernema carpocapsae | 0 | 25 | 35 | 40 | 60 | 70 |
| 4 | 10,000 indivs. of Steinernema carpocapsae | 0 | 60 | 100 | | | |
| 5 | 10 ppm of novaluron | 0 | 20 | 30 | 35 | 40 | 80 |
| 6 | 20 ppm of novaluron | 0 | 30 | 45 | 100 | | |
| 7 | 50 ppm of novaluron | 0 | 40 | 60 | 100 | | |
| 8 | 1,000 indivs. of Steinernema carpocapsae + | 0 | 40 | 100 | | | |
| | 10 ppm of novaluron | | | | | | |
| 9 | 1,000 indivs. of Steinernema carpocapsae + | 0 | 45 | 100 | | | |
| | 20 ppm of novaluron | | | | | | |
| 10 | 1,000 indivs. of Steinernema carpocapsae + | 0 | 100 | | | | |
| | 50 ppm of novaluron | | | | | | |
| 11 | 3,000 indivs. of Steinernema carpocapsae + | 0 | 65 | 100 | | | |
| | 10 ppm of novaluron | | | | | | |
| 12 | 3,000 indivs. of Steinernema carpocapsae + | 0 | 70 | 100 | | | |
| | 20 ppm of novaluron | | | | | | |
| 13 | 3,000 indivs. of Steinernema carpocapsae + | 0 | 75 | 100 | | | |
| | 50 ppm of novaluron | | | | | | |
| 14 | 10,000 indivs. of Steinernema carpocapsae + | 0 | 100 | | | | |
| | 10 ppm of novaluron | | | | | | |
| 15 | 10,000 indivs. of Steinernema carpocapsae + | 0 | 100 | | | | |
| | 20 ppm of novaluron | | | | | | |
| 16 | 10,000 indivs. of Steinernema carpocapsae + | 0 | 100 | | | | |
| | 50 ppm of novaluron | | | | | | |

As shown in Table 1, it is found that by combined use of an entomopathogenic nematode (Steinernema carpocapsae) and an insect-growth regulator (novaluron), more rapid insecticidal activity was exhibited compared with the samples that contained the materials singly.

### EXAMPLE 2

### Indoor Testing of Combined Use of an Entomopathogenic Nematode (Steinernema glaseri) and an insect-growth regulator (novaluron).

The tests (test numbers 17 to 32) were carried out in the same manner as in Example 1 except using Steinernema glaseri as an entomopathogenic nematode for combination with an insect-growth regulator (novaluron). In the tests using entomopathogenic nematodes, operation of diffusive volatilization was not carried out.

As treated soils for testing, as shown in Table 2, samples each containing 1000, 3000 or 10000 individuals of single Steinernema glaseri and samples each containing singly 10 ppm, 20 ppm or 50 ppm of novaluron, and samples containing a mixture of the prescribed amounts of Steinernema glaseri and novaluron were used.

In the glass bottle containing a non-treated soil, Coptotemes formosanus taken out from a nest was placed. Cumulative mortality rates after 0, 3, 5, 7, 10 and 14 days, respectively, were examined. The results are shown in Table 2.

TABLE 2

| | | Cumulative mortality rate (%) | | | | | |
|---|---|---|---|---|---|---|---|
| | | after a lapse of days | | | | | |
| | | Number of days elapsed | | | | | |
| Test No. | Composition of the treated soil | 0 | 3 | 5 | 7 | 10 | 14 |
| 17 | Non-treated | 0 | 0 | 0 | 0 | 0 | 0 |
| 18 | 1,000 indivs. of Steinernema glaseri | 0 | 10 | 15 | 20 | 30 | 35 |
| 19 | 3,000 indivs. of Steinernema glaseri | 0 | 15 | 18 | 23 | 36 | 45 |
| 20 | 10,000 indivs. of Steinernema glaseri | 0 | 45 | 55 | 78 | 98 | 98 |
| 21 | 10 ppm of novaluron | 0 | 20 | 30 | 35 | 40 | 80 |
| 22 | 20 ppm of novaluron | 0 | 30 | 45 | 100 | | |
| 23 | 50 ppm of novaluron | 0 | 40 | 60 | 100 | | |
| 24 | 1,000 indivs. of Steinernema glaseri + 10 ppm of novaluron | 0 | 35 | 69 | 100 | | |
| 25 | 1,000 indivs. of Steinernema glaseri + 20 ppm of novaluron | 0 | 40 | 80 | 100 | | |
| 26 | 1,000 indivs. of Steinernema glaseri + 50 ppm of novaluron | 0 | 100 | | | | |
| 27 | 3,000 indivs. of Steinernema glaseri + 10 ppm of novaluron | 0 | 50 | 100 | | | |
| 28 | 3,000 indivs. of Steinernema glaseri + 20 ppm of novaluron | 0 | 60 | 100 | | | |
| 29 | 3,000 indivs. of Steinernema glaseri + 50 ppm of novaluron | 0 | 55 | 100 | | | |
| 30 | 10,000 indivs. of Steinernema glaseri + 10 ppm of novaluron | 0 | 100 | | | | |
| 31 | 10,000 indivs. of Steinernema glaseri + 20 ppm of novaluron | 0 | 100 | | | | |
| 32 | 10,000 indivs. of Steinernema glaseri + 50 ppm of novaluron | 0 | 100 | | | | |

It is found that by combined use of an entomopathogenic nematode (Steinernema glaseri) and an insect-growth regulator (novaluron), more rapid insecticidal activity was exhibited compared with the samples that contained the materials singly.

### EXAMPLE 3

### Indoor Testing of Combined Use of Various Entomopathogenic Nematodes and an Insect-Growth Regulator (Novaluron).

The tests (test numbers 33 to 46) were carried out in the same manner as in Example 1 except using various entomopathogenic nematodes as shown in Table 3 as an entomopathogenic nematode for combination with an insect-growth regulator (novaluron). In the tests using entomopathogenic nematodes, operation of diffusive volatilization was not carried out.

As treated soils for testing, as shown in Table 3, samples each containing 3000 individuals of the respective entomopathogenic nematode and sample containing singly 10 ppm of novaluron, and samples containing a mixture of 3000 individuals of the respective entomopathogenic nematode and 10 ppm of novaluron were used.

In the glass bottle containing a non-treated soil, Coptotemes formosanus taken out from a nest was placed. Cumulative mortality rates after 0, 3, 5, 7, 10 and 14 days, respectively, were examined. The results are shown in Table 3.

TABLE 3

| | | Cumulative mortality rate (%) | | | | | |
|---|---|---|---|---|---|---|---|
| | | after a lapse of days | | | | | |
| | | Number of days elapsed | | | | | |
| Test No. | Composition of the treated soil | 0 | 3 | 5 | 7 | 10 | 14 |
| 33 | Not treated | 0 | 0 | 0 | 0 | 0 | 0 |
| 34 | Novaluron | 0 | 20 | 30 | 35 | 40 | 80 |
| 35 | Steinernema kushidai | 0 | 15 | 40 | 50 | 50 | 60 |
| 36 | Steinernema feltiae | 10 | 20 | 60 | 70 | 80 | 85 |
| 37 | Steinernema riobravis | 20 | 35 | 50 | 60 | 70 | 70 |
| 38 | Heterorhabditis bacteriophora | 0 | 0 | 20 | 35 | 60 | 70 |
| 39 | Heterorhabditis megidis | 0 | 0 | 40 | 40 | 40 | 40 |
| 40 | (Neo) Steinernema longicurvicauda | 0 | 40 | 60 | 70 | 70 | 75 |
| 41 | Steinernema kushidai + novaluron | 0 | 25 | 40 | 60 | 100 | |
| 42 | Steinernema feltiae + novaluron | 15 | 30 | 75 | 80 | 100 | |
| 43 | Steinernema riobravis + novaluron | 25 | 40 | 65 | 90 | 100 | |
| 44 | Heterorhabditis bacteriophora + novaluron | 0 | 30 | 55 | 85 | 100 | |
| 45 | Heterorhabditis megidis + novaluron | 0 | 25 | 60 | 75 | 100 | |
| 46 | (Neo) Steinernema longicurvicauda + novaluron | 0 | 40 | 60 | 70 | 100 | |

It is found that by combined use of an entomopathogenic nematode and an insect-growth regulator (novaluron), more rapid insecticidal activity was exhibited compared with the samples that contained the materials singly.

### EXAMPLE 4

### Indoor Testing of Combined Use of an Entomopathogenic Nematode (Steinernema carpocapsae) and an Insect-Growth Regulator (Diflubenzuron, Teflubenzuron).

The tests (test numbers 47 to 59) were carried out in the same manner as in Example 1 except using diflubenzuron or teflubenzuron as an insect-growth regulator for combination with an entomopathogenic nematode (Steinernema carpocapsae). In the tests using entomopathogenic nematodes, operation of diffusive volatilization was not carried out.

As treated soils for testing, as shown in Table 4, samples each containing singly 10 ppm, 20 ppm or 50 ppm of diflubenzuron or teflubenzuron, samples containing a mixture of 1000 individuals of Steinernema carpocapsae and the prescribed amounts of diflubenzuron, and samples containing a mixture of 1000 individuals of Steinernema carpocapsae and the prescribed amounts of teflubenzuron were used.

In the glass bottle containing a non-treated soil, Coptotemes formosanus taken out from a nest was placed. Cumulative mortality rates after 0, 3, 5, 7, 10 and 14 days, respectively, were examined. The results are shown in Table 4.

TABLE 4

| | | Cumulative mortality rate (%) | | | | | |
|---|---|---|---|---|---|---|---|
| | | after a lapse of days | | | | | |
| | | Number of days elapsed | | | | | |
| Test No. | Composition of the treated soil | 0 | 3 | 5 | 7 | 10 | 14 |
| 47 | Not treated | 0 | 0 | 0 | 0 | 0 | 0 |
| 48 | Diflubenzuron 10 ppm | 0 | 10 | 15 | 20 | 40 | 50 |
| 49 | Diflubenzuron 20 ppm | 0 | 25 | 35 | 40 | 50 | 60 |
| 50 | Diflubenzuron 50 ppm | 0 | 35 | 45 | 50 | 55 | 70 |
| 51 | Teflubenzuron 10 ppm | 0 | 20 | 25 | 30 | 30 | 55 |
| 52 | Teflubenzuron 20 ppm | 0 | 30 | 45 | 50 | 60 | 70 |
| 53 | Teflubenzuron 50 ppm | 0 | 40 | 60 | 70 | 80 | 90 |
| 54 | Steinernema carpocapsae + diflubenzuron 10 ppm | 0 | 25 | 30 | 40 | 70 | 90 |
| 55 | Steinernema carpocapsae + diflubenzuron 20 ppm | 0 | 30 | 40 | 60 | 100 | |
| 56 | Steinernema caxpocapsae + diflubenzuron 50 ppm | 0 | 40 | 70 | 80 | 100 | |
| 57 | Steinernema carpocapsae + teflubenzuron 10 ppm | 0 | 35 | 40 | 60 | 80 | 100 |
| 58 | Steinernema carpocapsae + teflubenzuron 20 ppm | 0 | 50 | 60 | 90 | 100 | |
| 59 | Steinernema carpocapsae + teflubenzuron 50 ppm | 0 | 75 | 90 | 100 | | |

It is found that by combined use of an entomopathogenic nematode (Steinernema carpocapsae) and an insect-growth regulator (diflubenzuron, teflubenzuron), more rapid insecticidal activity was exhibited compared with the samples that contained the materials singly.

### EXAMPLE 5

### Outdoor Testing of Combined Use of an Entomopathogenic Nematode (Steinernema carpocapsae) and an Insect-Growth Regulator (Novaluron).

The outdoor field tests (test numbers 60 to 64) were carried out in the ground of Takano High School (Kagoshima prefecture) using an entomopathogenic nematode (Steinernema carpocapsae) and an insect-growth regulator (novaluron).

Novaluron dissolved in acetone was injected into sapwood of Japanese cedar under reduced pressure so as to adjust novaluron weight to sapwood weight at 0.5% w/w, thereby making a treated pile (novaluron-containing bait agent) containing 500 mg of novaluron to 100 g of Japanese cedar sapwood.

In the place where action of Coptotemes formosanus was observed with a monitoring pile that had previously been installed, twenty novaluron-containing bait agents were installed, and an entomopathogenic nematode (Steinernema carpocapsae) was spread at a rate of 13 million individuals per square meter around the place where the novaluron-containing bait agents were installed and 20 m² of the ground where action of Coptotemes formosanus was observed.

After three months, eating damage of the novaluron-containing bait agents and termite mortality rate were examined. Termite mortality rate was calculated based on the equations below, after digging out of the ground around the novaluron-containing bait agents to find five colonies (nests), and arbitrarily taking out termites in each colony from the soil. The results are shown in Table 5.

Mortality rate (%)={(number of dead termites)/(number of examined individuals of termites)}×100

Mortality rate due to nematode (%)={(number of dead termites due to nematode)/(number of dead termites)}×100

TABLE 5

| | | | | | Mortality |
|---|---|---|---|---|---|
| | Number of | | | Number of | rate |
| | examined | Number of | | dead termites | due to |
| Test | individuals of | dead | Mortality | due to | nematode |
| No. | termites | termites | Rate (%) | nematode | (%) |
| 60 | 38 | 38 | 100 | 30 | 79 |
| 61 | 40 | 35 | 88 | 28 | 80 |
| 62 | 52 | 50 | 96 | 37 | 74 |
| 63 | 28 | 28 | 100 | 25 | 89 |
| 64 | 61 | 58 | 95 | 46 | 79 |

As a result of the examination on eating damage of the bait agents, action of eating damage by Coptotemes formosanus was observed in five agents out of twenty agents. 40 g of Japanese cedar sapwood and 200 mg of novaluron were found, based on the weight reduction, to have been taken into the colonies.

And as seen from Table 5, mortality rates of five populations arbitrarily taken out of the colonies of nidificating Coptotemes formosanus were all very high, and the ratio of dead termites infected with nematodes was more than 79%. Most of the survived Coptotemes formosanus were young termites that had just hatched out of eggs. Based on this fact, it can be considered that those young termites will be gradually exterminated by eating the termite carcasses and being in the nest for a long time.

INDUSTRIAL APPLICABILITY

According to the present invention, by the use of an entomopathogenic nematode together with an insect-growth regulator or a slow-acting insecticide, synergistic exterminating effect can be obtained, thereby surely exterminating termites that damage architectural structures and that try to intrude therein, and eradicating colonies of termites that nidificate in their habitat.

Furthermore, by the use of an entomopathogenic nematode together with an insect-growth regulator or a slow-acting insecticide, exterminating termites can be carried out with an extremely reduced amount of chemical insecticides than the amount conventionally used, thereby enabling environmentally and sanitarily preferable extermination of termites.

1. A method for exterminating termites comprising using an entomopathogenic nematode together with an insect-growth regulator or a slow-acting insecticide, wherein insecticidal effects are reinforced compared with the cases using singly the entomopathogenic nematode and the insect-growth regulator or the slow-acting insecticide, respectively.

2. The method for exterminating termites according to claim 1, wherein the entomopathogenic nematode belongs to the family Steinernematidae.

3. The method for exterminating termites according to claim 2, wherein the nematode belonging to the family Steinernematidae belongs to the genus Steinernema, Heterorhabditis or Neosteinernema.

4. The method for exterminating termites according to claim 3, wherein the entomopathogenic nematode belonging to the genus Steinernema is Steinernema carpocapsae, Steinernema glaseri, Steinernema kushidai, Steinernema feltiae or Steinernema riobravis, the entomopathogenic nematode belonging to the genus Heterorhabditis is Heterorhabditis bacteriophora or Heterorhabditis megidis, or the entomopathogenic nematode belonging to the genus Neosteinernema is Neosteinernema longicurvicauda.

5. The method for exterminating termites according to claim 1, wherein the insect-growth regulator is selected from triflumuron, diflubenzuron, teflubenzuron, hexaflumuron, lufenuron, novaluron, flufenoxuron, chlorfluazuron, cyromazine, methoprene, hydroprene, pyriproxyfen, fenoxycarb and kinoprene.

6. The method for exterminating termites according to claim 1, wherein a bait station containing an entomopathogenic nematode with an insect-growth regulator or a slow-acting insecticide is used.

7. The method for exterminating termites according to claim 1, wherein a bait station containing an insect-growth regulator or a slow-acting insecticide is installed, and then entomopathogenic nematodes are spread around the bait station.

8. The method for exterminating termites according to claim 1, wherein together with treating termites with an insect-growth regulator or a slow-acting insecticide, entomopathogenic nematodes are spread over or around the treated termites.

9. A bait station for use in a method for exterminating termites according to any one of claims 1 to 7, wherein the bait station contains an insect-growth regulator or a slow-acting insecticide.

10. A bait station for use in a method for exterminating termites according to any one of claims 1 to 6, wherein the bait station contains an entomopathogenic nematode together with an insect-growth regulator or a slow-acting insecticide.
